(19) United States
(12) Patent Application Publication
(10) Pub. No.: US 2010/0236878 A1
(43) Pub. Date: Sep. 23, 2010

(54) DISC BRAKE

(75) Inventor: Toshifumi MAEHARA, Tokyo (JP)

Correspondence Address: DRINKER BIDDLE & REATH (DC), 1500 K STREET, N.W., SUITE 1100, WASHINGTON, DC, 20005-1209, US

(73) Assignee: AKEBONO BRAKE INDUSTRY CO., LTD., Tokyo (JP)

(21) Appl. No.: 12/720,934

(22) Filed: Mar. 10, 2010

(30) Foreign Application Priority Data
Mar. 23, 2009 (JP) 2009-069629

(51) Int. Cl. F16D 65/095

(52) U.S. Cl. 188/73.36

(57) ABSTRACT

Among abutment parts (Af, Bf, Cf, Ar) of pad-side engagement parts (11a, 11b) and support-member-side engagement parts (10a, 10a), a portion (Af) which bears a tangential force (Ff) applied to the pad (5a, 6a) during a forward rotation of the rotor on a forward side of the forward rotation of the rotor is positioned inwardly in a radial direction of a rotor with respect to a virtual tangent (k) at a centroid (O) of the pad (5a, 6a) of a virtual circle having a center identical with a center of the rotor and passing through said centroid (O). Among the abutment parts (Af, Bf, Cf, Ar), portions (Bf, Cf) which bear a rotational moment (Mf) applied to the pad (5a, 6a) during the forward rotation of the rotor are positioned at the circumferential both end parts of a support member (2a) and outwardly in the radial direction of the rotor with respect to the virtual tangent (k).

### BACKGROUND OF THE INVENTION

1. Field of the Invention

The present invention relates to an improvement in a disc brake used to perform braking of an automobile. Specifically, the present invention is intended to achieve implementation of a structure capable of stabilizing an attitude of a pad and reducing a drag and a vibration (an abnormal noise and a judder) of the pad in a floating caliper type disc brake.

2. Background Art

Conventionally, as a disc brake for performing braking of vehicles such as an automobile and the like, a floating caliper type disc brake is widely used. In the floating caliper type disc brake, a caliper is supported with respect to a support member so as to be displaceable in an axial direction, and a cylinder part and a piston are provided in the caliper on only one side of a rotor. Such floating caliper type disc brake is disclosed in, for example, Patent Documents 1 to 3.

Patent Document 1: JP-A-07-077229

Patent Document 2: U.S. Pat. No. 6,186,288

Patent Document 3: JP-A-2001-234955

FIGS. 7 to 9 show the floating caliper type disc brake which is described in Patent Document 2. In the disc brake, a caliper 3 is supported with respect to a support member 2 fixed adjacent to a rotor 1 which rotates together with a wheel so as to be displaceable in an axial direction of the rotor 1 (a vertical direction in FIG. 7, a direction of going-into/coming-out of the page in FIG. 8, and a lateral direction in FIG. 9) using a pair of guide pins 4 and 4. In addition, both end parts of inner-side and outer-side pads 5 and 6 are supported with respect to the support member 2 so as to be displaceable in the axial direction of the rotor 1. Further, the caliper 3 having a cylinder part 7 and a caliper claw 8 is disposed so as to stride over the pads 5 and 6, and a piston 9 for pressing the inner-side pad 5 against the rotor 1 is provided in the cylinder part 7.

When braking is performed, pressure oil is supplied into the cylinder part 7, and the inner-side pad 5 is pressed against an inner-side surface of the rotor 1 in a direction from an upper side to a lower side in FIG. 7 (from a right side to a left side in FIG. 9) by the piston 9. Then, the caliper 3 is displaced toward the upper side in FIG. 7 (toward the right side in FIG. 9) as reaction to this pressing force, and the caliper claw 8 presses the outer-side pad 6 against an outer-side surface of the rotor 1. As the result, the rotor 1 is tightly held from sides with both of the inner-side and outer-side surfaces, and the braking is thereby performed.

At both end parts in a circumferential direction of the rotor 1 in both side portions of the support member 2 which strides over the rotor 1, support-member-side engagement parts 10 and 10 are formed. In addition, at both end parts in the circumferential direction of the rotor 1 of inner-side and outer-side pressure plates 12 and 13 which constitute the inner-side and outer-side pads 5 and 6, pad-side engagement parts 11 and 11 are formed. On the basis of engagement of the support-member-side and pad-side engagement parts 10 and 11, braking force acting on the inner-side and outer-side pads 5 and 6 during the braking is born and, at the same time, the pads 5 and 6 are supported so as to be displaceable in the axial direction.

Further, between the circumferential both end parts of the inner-side and outer-side pressure plates 12 and 13 and the support member 1, pad clips 14a and 14b are disposed to prevent the inner-side and outer-side pads 5 and 6 from rattling against the support member 2, and the support-member-side and pad-side engagement parts 10 and 11 from becoming rusty and thereby sticking to each other. The pad clips 14a and 14b of this type are formed by bending a metal plate having corrosion resistance and elasticity such as a stainless spring steel plate or the like and, as indicated by arrows α and α in FIG. 8, the inner-side and outer-side pads 5 and 6 are pressed outwardly in a radial direction of the rotor 1 and, as indicated by arrows β and β, the pad-side engagement parts 11 and 11 are pressed in a direction moving away from the support-member-side engagement parts 10 and 10.

A description will be given of force applied to the support member 2 from the inner-side and outer-side pads 5 and 6 during braking of the disc brake constituted in the manner described above by using FIGS. 10 and 11. It is to be noted that FIG. 10 shows a state when viewed from the outer side with the caliper 3 (see, e.g. , FIGS. 7 to 9) being omitted, while FIG. 11 shows a state where the inner-side pad 5 is viewed from the rotor side (the state of FIG. 10 is cut by the XI-XI line of FIG. 10 and viewed from the lower left side in the drawing). During the braking, as indicated by arrows in FIG. 10, the inner-side and outer-side pads 5 and 6 are relatively displaced in a direction that they approach each other.

First, consideration will be given to a case when a forward rotation (a forward travel) in which the rotor 1 (see, e.g., FIGS. 7 to 9) rotates, e.g., in a direction of an arrow X of FIG. 11 (a counterclockwise direction) is performed. When it is considered that tangential force Ff on the basis of braking is applied to a centroid O of each of the inner-side and outer-side pads 5 and 6 (a centroid O of each of frictional materials 31 constituting the inner-side and outer-side pads 5 and 6) during the forward rotation, the tangential force Ff is born by an abutment part Af in the support member 2 of the support-member-side engagement part 10 and the pad-side engagement part 11 which are on a forward side in a direction of rotation of the rotor 1 (a rotation-out side and the left side in FIG. 11). Subsequently, moment (rotation force) Mf on the basis of a difference Sf between the direction of application of the tangential force Ff and the position of the abutment part Af, i.e., the moment Mf in the counterclockwise direction in FIG. 11 with the abutment part Af as a pivot is applied to each of the inner-side and outer-side pads 5 and 6. In addition, the moment (the rotation force) Mf is born by an abutment part Bf of a pressing part of the pad clip 14a and the pad-side engagement part 11 which are on the forward side in the direction of rotation of the rotor 1, and an abutment part Cf in the support member 2 of the support-member-side engagement part 10 and the pad-side engagement part 11 which are on a backward side in the direction of rotation of the rotor 1 (a rotation-in side and the right side in FIG. 11).

On the other hand, consideration will be given to a case when a reverse rotation (a backward travel) in which the rotor 1 rotates, e.g., in a direction of an arrow Y of FIG. 11 (a clockwise direction) is performed. When it is considered that tangential force Fr on the basis of the braking is applied to the centroid O of each of the inner-side and outer-side pads 5 and 6 during the reverse rotation, the tangential force Fr is born by an abutment part Ar in the support member 2 of the support-member-side engagement part 10 and the pad-side engagement part 11 which are on the forward side in the direction of rotation of the rotor 1 (the rotation-out side and the right side in FIG. 11). Subsequently, moment (the rotation force) Mr on the basis of a difference Sr between the direction of application of the tangential force Fr and the position of the abutment part Ar, i.e., the moment Mr in the clockwise direction with the abutment part Ar as the pivot is applied to each of the inner-side and outer-side pads 5 and 6. In addition, the moment (the rotation force) Mr is born by an abutment part Br of the pad clip 14b and the pad-side engagement part 11 which are on the forward side in the direction of rotation of the rotor 1, and an abutment part Cr in the support member 2 of the support-member-side engagement part 10 and the pad-side engagement part 11 which are on the backward side in the direction of rotation of the rotor 1 (the rotation-in side and the left side in FIG. 11).

By the way, in the case of the above-described structure, the attitudes of the inner-side and outer-side pads 5 and 6 are likely to be unstable, and there is a possibility that a drag and a vibration become likely to occur. A description will be given hereinbelow of this point. That is, in the case of the above-described structure, for example, during the forward rotation (the forward travel), each of the inner-side and outer-side pressure plates 12 and 13 is supported (held) by three points of the respective abutment parts Af, Bf, and Cf during braking. However, as indicated by a diagonal lattice pattern in FIG. 11, an area of a triangle obtained by joining the three supportive points Af, Bf, and Cf is small {a width thereof in the radial direction of the rotor 1 is small (narrow)}, and it is difficult to secure support stiffness in a direction of going-into/coming-out of the page of the drawing (which is the axial direction of the rotor). That is, each of the inner-side and outer-side pads 5 and 6 becomes likely to swing in the direction of going-into/coming-out of the page of FIG. 11 with the triangle obtained by joining the three supportive points Af, Bf, and Cf as the swing center, and the attitudes of the pads 5 and 6 are likely to be unstable.

In particular, concurrently with the swing of the rotor 1 in the axial direction at the time of release of the braking, the inner-side and outer-side pads 5 and 6 are pressed by axial side surfaces of the rotor 1 in a direction moving away from the rotor 1. However, even when the pads 5 and 6 are pressed in this manner, there is a possibility that each of the pads 5 and 6 disadvantageously swings in the axial direction of the rotor with the triangle obtained by joining the three supportive points Af, Bf, and Cf as the swing center so that the pads 5 and 6 become less likely to be displaced (retracted) in the axial direction of the rotor 1. Since the swing amount of the rotor 1 in the axial direction increases as it goes outward in the radial direction of the rotor 1, a portion of each of the inner-side and outer-side pads 5 and 6 which is positioned far away outwardly from the triangle obtained by joining the three supportive points Af, Bf, and Cf tends to be pressed by the rotor 1 in the axial direction of the rotor.

Consequently, on the basis of the pressing of the rotor 1 mentioned above, the inner-side and outer-side pads 5 and 6 tend to swing in the axial direction of the rotor as described above to become less likely to be displaced (retracted) in the axial direction of the rotor 1. When the inner-side and outer-side pads 5 and 6 are not displaced (retracted) adequately, there is a possibility that the drag of the pads 5 and 6 with respect to the rotor 1 becomes excessive and, at the same time, the pads 5 and 6 excessively vibrate on the basis of the swing (causing an abnormal noise and judder) , which is not desirable.

In addition, in the case of the above-described structure, the direction of the moment Mf during the forward rotation (the forward travel) and the direction of the moment Mr during the reverse rotation (the backward travel) which are applied to the inner-side and outer-side pads 5 and 6 are opposite to each other. Further, during either rotation (during the forward rotation and during the reverse rotation), the moment Mf or Mr is applied to the pad clip 14a or 14b in a direction opposing the pressing force of the pad clip 14a or 14b (an opposite direction). For example, during the forward rotation, the moment Mf is applied in a direction opposing the arrow α indicative of elastic force of the pad clip 14a on the forward side in the direction of rotation of the rotor 1. On the other hand, during the reverse rotation, the moment Mr is applied in a direction opposing the arrow a indicative of the elastic force of the pad clip 14b on the forward side in the direction of the rotation. Accordingly, the pad clips 14a and 14b become easily worn, and the force (restraining force) for pressing the inner-side and outer-side pads 5 and 6 by the pad clips 14a and 14b become likely to be reduced so that, in terms of this aspect, there is a possibility that the attitudes of the pads 5 and 6 become unstable. In addition, since the direction of application of the moment is different during the forward rotation and during the reverse rotation as described above, for example, the engagement parts on the forward side in the direction of rotation of the rotor 1 abut on (collide with) each other when the braking is started, and there is a possibility that the abnormal noise resulting from the abutment (collision) becomes likely to occur.

### SUMMARY OF THE INVENTION

One or more embodiments of the invention provides a disc brake in which an attitude of a pad is stabilized and a drag and a vibration (an abnormal noise and a judder) of the pad is reduced.

In accordance with one or more embodiments of the invention, a disc brake is provided with: a support member 2a to be fixed to a vehicle body so as to be adjacent to a rotor rotating together with a wheel; a pad 5a, 6a supported by the support member 2a so as to be displaceable in an axial direction of the rotor, wherein a braking torque applied to the pad 5a, 6a during braking is born by an engagement of support-member-side engagement parts 10a, 10a provided at circumferential both end parts of the support member 2a and pad-side engagement parts 11a, 11b provided at circumferential both end parts of a pressure plate 12a, 13a of the pad 5a, 6a; a caliper which is supported by a part of the support member and configured to press the pad toward a surface of the rotor; and pad clips 15a, 15b disposed between the support-member-side engagement parts 10a, 10a and the pad-side engagement parts 11a, 11b. Among abutment parts Af, Bf, Cf, Ar of the pad-side engagement parts 11a, 11b and the support-member-side engagement parts 10a, 10a which butt to each other through the pad clips 15a, 15b, a portion Af which bears a tangential force Ff applied to the pad 5a, 6a during a forward rotation (a forward travel) of the rotor on a forward side (a rotation-out side) of the forward rotation of the rotor is positioned inwardly in a radial direction of the rotor with respect to a virtual tangent k at a centroid O of the pad 5a, 6a (a geometric center of a frictional surface of the pad=a geometric center of a frictional material constituting the pad when viewed from the rotor side) of a virtual circle having a center identical with a center of the rotor and passing through said centroid O. Among said abutment parts Af, Bf, Cf, Ar, portions Bf, Cf which bear a rotational moment Mf (rotation force) applied to the pad 5a, 6a during the forward rotation of the rotor are positioned at the circumferential both end parts of the support member 2a and outwardly in the radial direction of the rotor with respect to the virtual tangent k.

Further, according to a second aspect of the invention, in the above structure, among said abutment parts Af, Bf, Cf, Ar, a portion Ar which bears a tangential force Fr applied to the pad 5a, 6a during a reverse rotation (a backward travel) of the rotor on a forward side (the rotation-out side) of the reverse rotation of the rotor may be positioned outwardly in the radial direction of the rotor with respect to the virtual tangent k. Moreover, one 11b of the pad-side engagement parts 11a, 11b which is on a backward side (a rotation-in side) of the forward rotation during the forward rotation of the rotor may include a inclined surface part 29 which is inclined inwardly in the radial direction of the rotor as it goes toward the centroid O in a direction of the virtual tangent k. The inclined surface part 29 may be pressed by one 15b of the pad clips 15a, 15b.

According to the disc brake constituted in the above-described manner, it is possible to achieve the stabilization of the attitude of the pad, and reduce the drag and the vibration (the abnormal noise and the judder) of the pad.

That is, during the forward rotation of the rotor, the pad is supported (held) by the following three points with respect to the support member. First, one of the three points corresponds to a portion which is on the forward side in the direction of rotation of the rotor (the rotation-out side) during the forward rotation (the forward travel) of the rotor, and bears the tangential force applied to the pad, and this portion is positioned inwardly of the virtual tangent in the radial direction of the rotor. Further, the remaining two points correspond to portions which bear the moment (the rotation force) applied to the pad, and this portions are positioned at the circumferential both end parts of the support member and outwardly of the virtual tangent in the radial direction. Accordingly, it is possible to enlarge a triangle obtained by joining the three supportive points {increase (widen) the width in the radial direction of the rotor}, and facilitate securement of support stiffness of the pad in the axial direction of the rotor. As the result, the pad becomes less likely to swing in the axial direction of the rotor with the triangle obtained by joining the three supportive points as a swing center, and it is possible to achieve the stabilization of the attitude of the pad.

Furthermore, since the two points out of the three supportive points constituting the triangle are positioned outwardly of the virtual tangent in the radial direction, concurrently with the swing of the rotor in the axial direction at the time of release of the braking, when the pad is pressed in a direction moving away from the rotor by an axial side surface of the rotor, it is possible to reliably displace (retract) the pad in the direction moving away from the rotor on the basis of the pressing. In particular, the swing amount of the rotor in the axial direction increases as it goes outward in the radial direction of the rotor and, according to the embodiments of the invention, since the two points out of the three supportive points are positioned outwardly of the virtual tangent in the radial direction, the triangle obtained by joining the three supportive points and the portion pressed by the rotor can be superimposed on each other or brought toward each other in the radial direction of the rotor. Consequently, it is possible to secure the support stiffness (render the pads less likely to swing) as described above and, at the same time, cause the pad to reliably recede while the stable attitude of the pad is maintained, and it is possible to thereby achieve reductions in the drag of the pad with respect to the rotor and the vibration (the abnormal noise and the judder) of the pad.

In addition, in the case of the second aspect of the invention, it is possible to have the same direction for the moment during the forward rotation (the forward travel) and the moment during the reverse rotation (the backward travel) which are applied to the pads, and it is also possible to impart the elastic force of the pad clips for pressing the pads in the same direction as that of application of the moment. Accordingly, it is possible to press the pads in the same direction (the same direction as that of the moment) at all times, and reliably achieve the prevention of the pads from rattling. More specifically, it is possible to cause the abutment parts between each of the pad and the support member (the abutment parts between the pad-side engagement parts and the support-member-side engagement parts) to abut on each other in the same direction at all times, and it is possible to, e. g. , prevent the occurrence of the abnormal noise resulting from the abutment (collision) of the engagement parts on the forward side in the direction of rotation of the rotor when the braking is started irrespective of the forward rotation or the reverse rotation. In addition, since the direction in which the elastic force of the pad clips is imparted and the direction in which the moment is applied become the same direction, it is possible to render the force (the restraining force) for pressing the pads by the pad clips less likely to be reduced and, in terms of this aspect, achieve the stabilization of the attitudes of the pads.

Other aspects and advantages of the invention will be apparent from the following description, the drawings and the claims.

### BRIEF DESCRIPTION OF THE DRAWINGS

FIG. 1 is a perspective view showing an exemplary embodiment of the invention when viewed from an outer side and an outside in a radial direction of a rotor with the rotor omitted and a caliper removed.

FIG. 2 is an orthographic projection when viewed from the outside in the radial direction of the rotor.

FIG. 3 is an orthographic projection when viewed from a right side in FIG.. 2.

FIG. 4 is an orthographic projection when viewed from an inner side as an upper side in FIG. 2.

FIG. 5 is an orthographic projection when viewed from the outer side as a lower side in FIG. 2.

FIG. 6 is a cross-sectional view taken along the VI-VI line of FIG. 2.

FIG. 7 is a partially cut-out view showing an example of a conventional structure when viewed from the outside in the radial direction of the rotor.

FIG. 8 is a view when viewed from the outer side as the lower side in FIG. 7.

FIG. 9 is a cross-sectional view taken along the line IX-IX of FIG. 8.

FIG. 10 is a view similar to FIG. 1 for explaining force applied to a pad and a support member.

FIG. 11 is a cross-sectional view taken along the line XI-XI of FIG. 10.

### DETAILED DESCRIPTION OF THE EXEMPLARY EMBODIMENTS

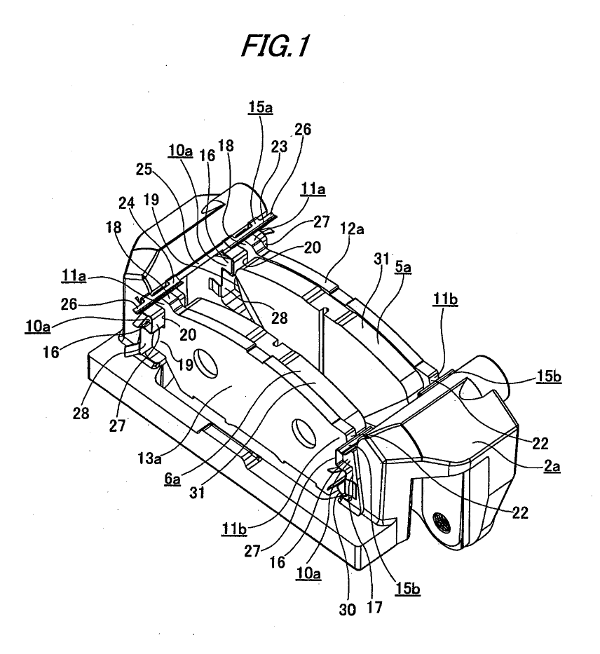

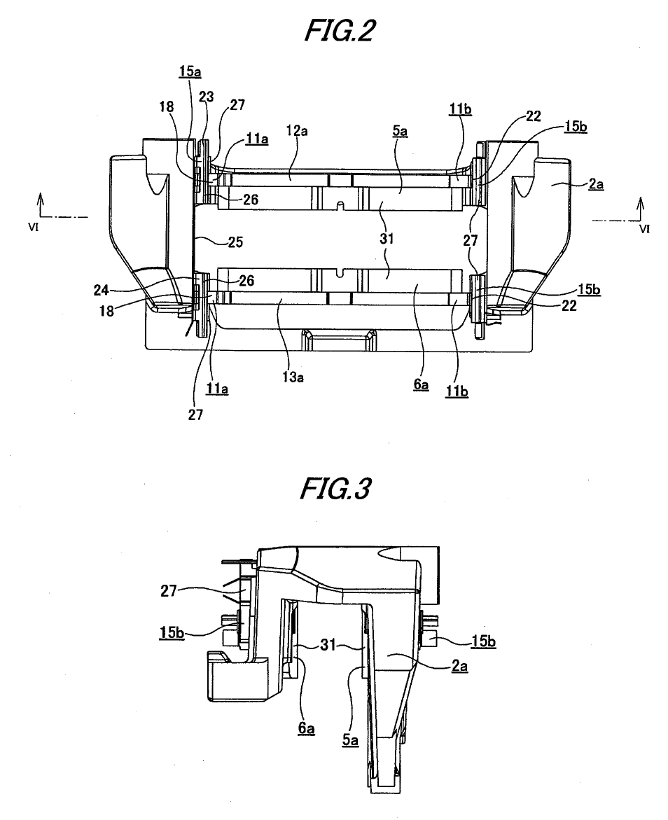

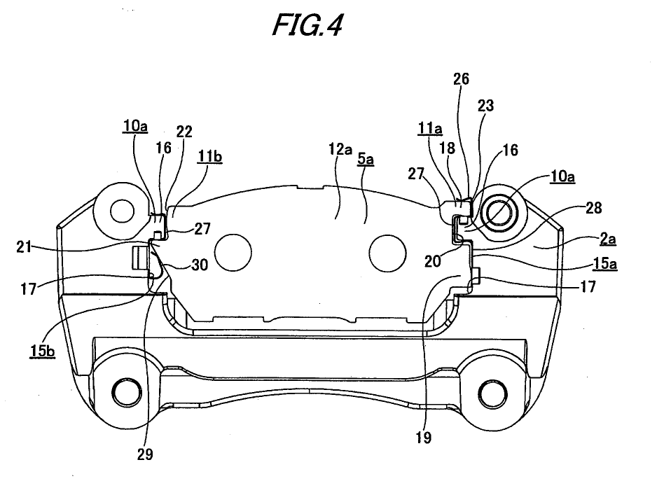

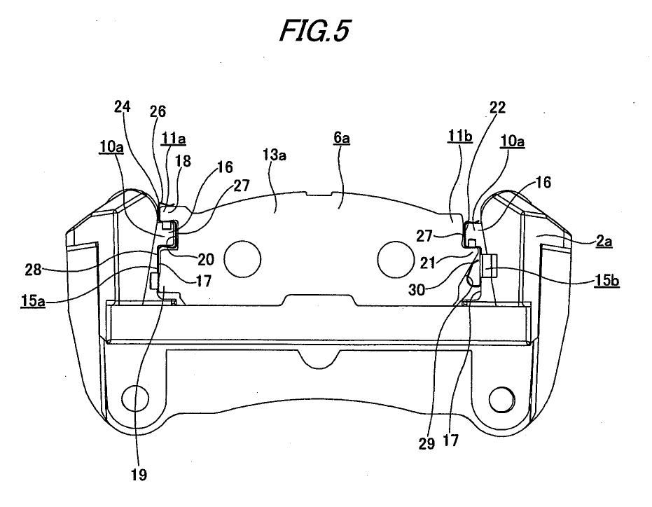

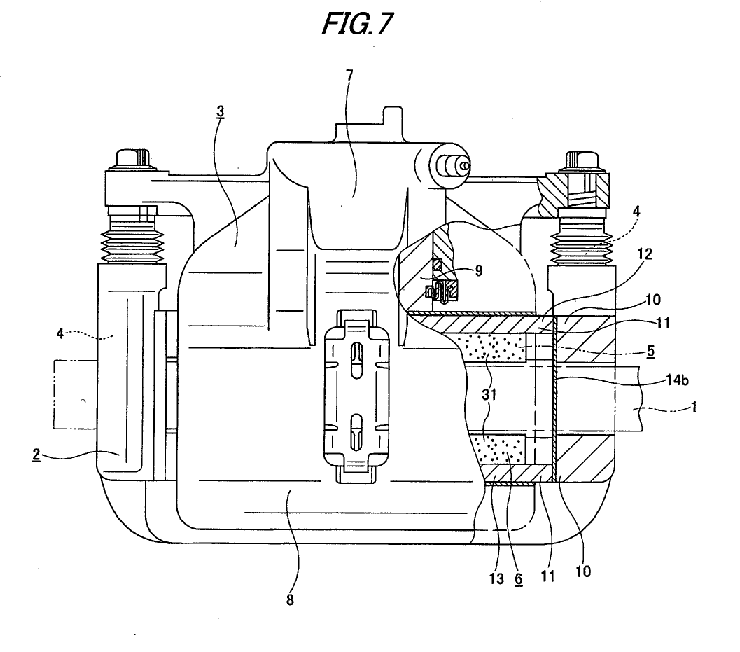

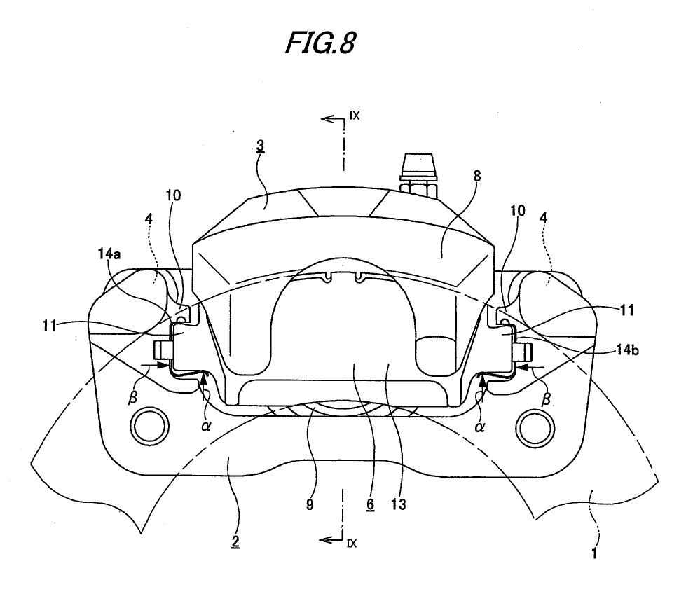

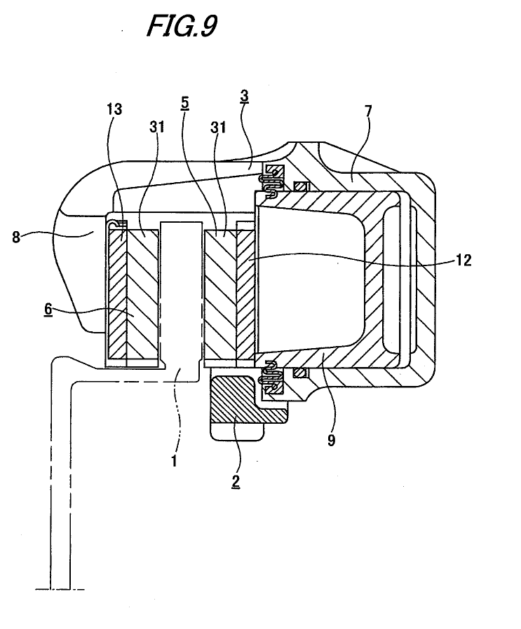

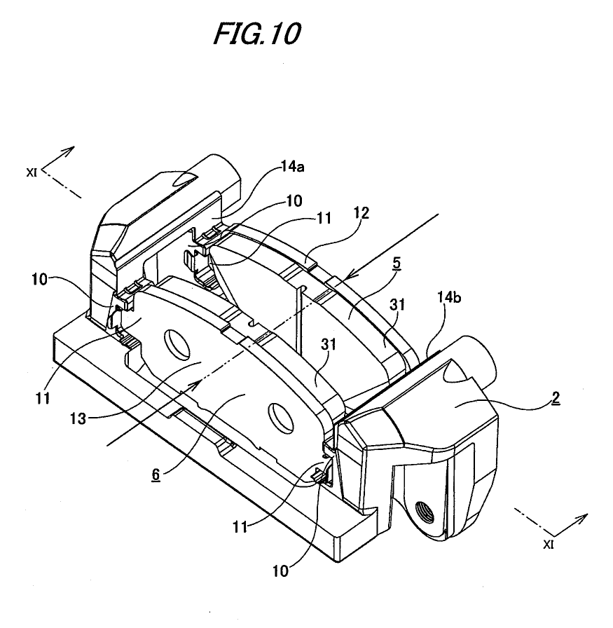

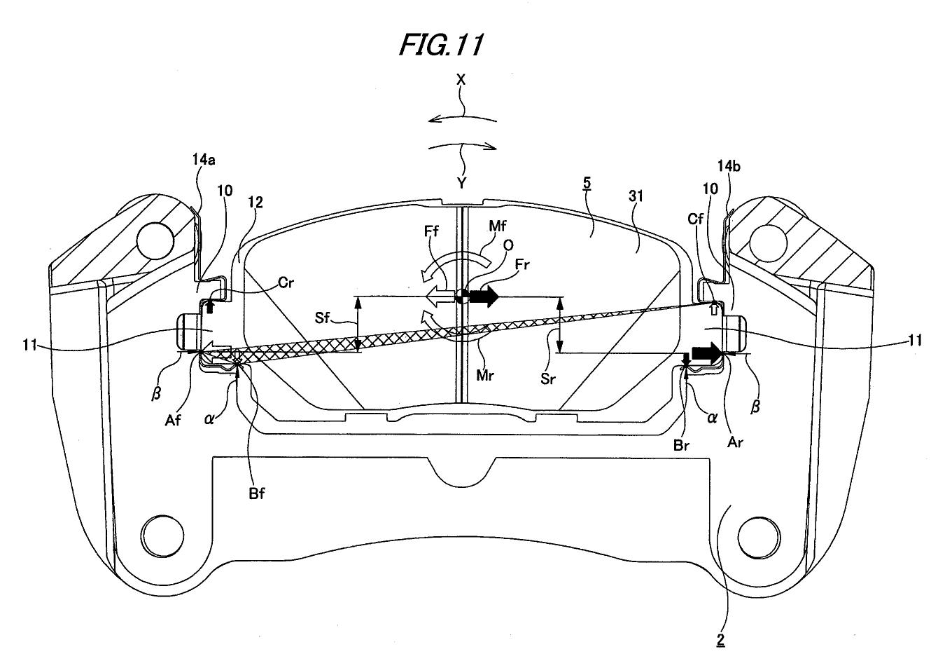

FIGS. 1 to 6 show an exemplary embodiment of the invention. In the disc brake of the exemplary embodiment, in order to achieve stabilization of attitudes of inner-side and outer-side pads 5a and 6a and, in turn, reductions in a drag and a vibration (an abnormal noise and a judder) of the pads 5a and 6a, a structure of a portion for supporting the pads 5a and 6a with respect to a support member 2a, and structures of pad clips 15a and 15b are devised. Since configurations and operations of other portions are similar to, e.g., those of a conventional structure shown in FIGS. 7 to 11 described above, depictions and descriptions of corresponding portions will be omitted or simplified, and a description will be given mainly of characteristic portions of the present example.

In the case of the exemplary embodiment as well, at both end parts in the circumferential direction of the rotor 1 in both side portions of the support member 2a which strides over the rotor 1 (see FIGS. 7 to 9), support-member-side engagement parts 10a and 10a are formed. In addition, at both end parts in the circumferential direction of the rotor 1 of inner-side and outer-side pressure plates 12a and 13a constituting the inner-side and outer-side pads 5a and 6a, pad-side engagement parts 11a and 11b are formed. On the basis of engagement of the support-member-side and pad-side engagement parts 10a, 11a, and 11b, braking force acting on the inner-side and outer-side pads 5a and 6a is born during the braking, and the pads 5a and 6a are supported so as to be displaceable in the axial direction.

In the case of the exemplary embodiment, the support-member-side engagement parts 10a and 10a are provided with convex parts 16 and 16 and concave parts 17 and 17 in this order from the outside in the radial direction of the rotor 1. Further, the support-member-side engagement parts 10a on one side in the circumferential direction of the rotor (e.g., the rotation-in side) and the support-member-side engagement parts 10a on the other side in the circumferential direction of the rotor (e.g., the rotation-out side) are formed to be symmetrical with each other. That is, the support-member-side engagement parts 10a and 10a are formed to be symmetrical with each other with respect to a virtual plane which includes the center axis of the rotor 1 and passes through a central part of the support member 2a in a width direction. Consequently, the configuration of the support member 2a is not complicated (can be simplified) so that it is possible to achieve facilitation of the working of the support member 2a. In addition, when the support member 2a is assembled into in a vehicle, the same support member can be mounted on both sides of the vehicle in the width direction (commonality of parts can be achieved), and an improvement in productivity and, in turn, a reduction in cost can be achieved.

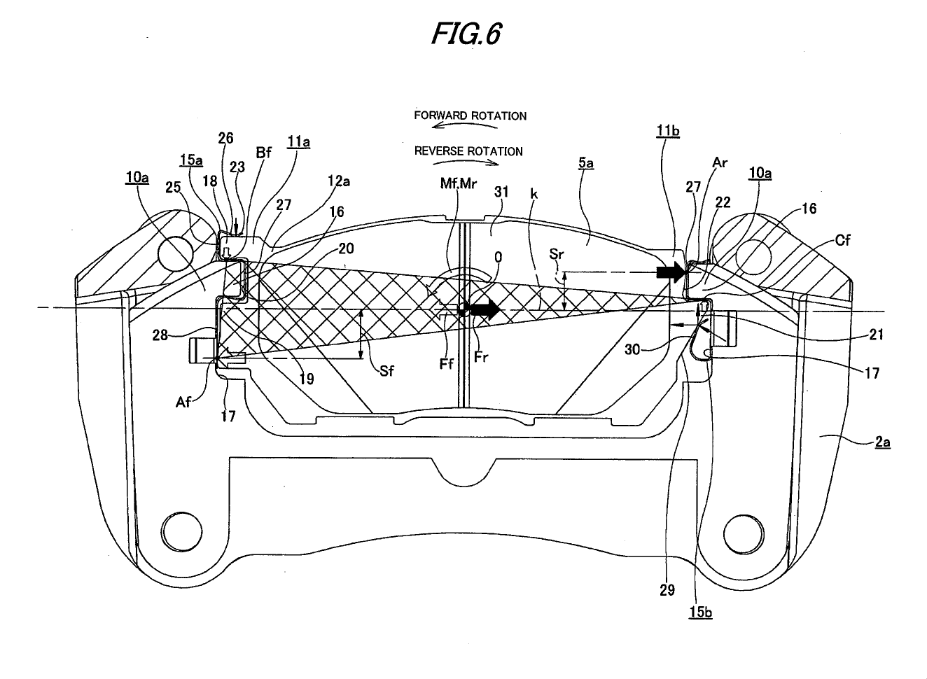

Among the pad-side engagement parts 11a and 11b, each of the pad-side engagement parts 11a which are on a forward side in a direction of rotation of the rotor 1 (a rotation-out side and, e.g., the left side in FIG. 6) during a forward rotation (a forward travel) of the rotor 1 is provided with a first protrusion part 18, a second protrusion part 19, and a first recessed part 20 between the first and second protrusion parts 18 and 19. Further, in the same manner, each of the pad-side engagement parts 11b which are on the forward side in the direction of rotation of the rotor 1 (the rotation-out side and, e.g., the right side in FIG. 6) during a reverse rotation (a backward travel) of the rotor 1 is provided with a third protrusion part 21 positioned in the middle portion in the radial direction of the rotor 1, and a second recessed part 22 which is positioned on the outside in the radial direction of the rotor 1, and is recessed into the top portion of the third protrusion part 21. Between the above-described pad-side engagement parts 11a and 11b and the above-described support-member-side engagement parts 10a and 10a, the pad clips 15a and 15b for preventing the inner-side and outer-side pads 5a and 6a from rattling against the support member 2a are disposed.

In the case of the exemplary embodiment, among the pad-side engagement parts 11a and 11b, between the pad-side engagement parts 11a which are on the forward side in the direction of rotation of the rotor 1 during the forward rotation of the rotor 1 and the support-member-side engagement parts 10a opposing the pad-side engagement parts 11a, the pad clip 15a which is integrally formed between the inner and outer sides is disposed. The pad clip 15a has an inner-side clip part 23, an outer-side clip part 24, and a connection part 25 for connecting the inner-side and outer-side clip parts 23 and 24. The inner-side and outer-side clip parts 23 and 24 respectively have first pressing parts 26 and 26 which abut on outer circumferential surfaces of the first protrusion parts 18 (surfaces in correspondence to the outer circumferential side of the rotor 1) constituting the pad-side engagement parts 11a, and press the inner-side and outer-side pads 5a and 6a inwardly in the radial direction of the rotor 1, crank parts 27 and 27 which cover the convex parts 16 along the contours of the convex parts 16 constituting the support-member-side engagement parts 10a, and flat plate parts 28 and 28 which are held between the second protrusion parts 19 constituting the pad-side engagement parts 11a and the concave parts 17 constituting the support-member-side engagement parts 10a.

On the other hand, among the pad-side engagement parts 11a and 11b, between the pad-side engagement parts 11b which are on the forward side in the direction of rotation of the rotor 1 during the reverse rotation of the rotor 1 and the support-member-side engagement parts 10a opposing the pad-side engagement parts 11b, the pad clips 15b and 15b which are individually formed on the inner side and on the outer side are disposed. The pad clips 15b and 15b abut on inclined surface parts 29 of the third protrusion parts 21 constituting the pad-side engagement parts 11a, and respectively have second pressing parts 30 which press the inner-side and outer-side pads 5a and 6a outwardly in the radial direction of the rotor 1 and also toward the centers of the pads 5a and 6a, and the crank parts 27 which cover the convex parts 16 along the contours of the convex parts 16 constituting the support-member-side engagement parts 10a. It is to be noted that each of the inclined surface parts 29 is present inwardly of the top portion of the third protrusion part 21 in the radial direction of the rotor 1, and is inclined toward the center of the pad 5a or 5b as it goes inward in the radial direction.

In addition, in the case of the exemplary embodiment, among abutment parts of the pad-side engagement parts 11a and 11b and the support-member-side engagement parts 10a and 10a which abut on each other via the above-described pad clips 15a and 15b, a position of a portion Af which is on the forward side in the direction of rotation of the rotor 1 during the forward rotation of the rotor 1, and bears tangential force Ff applied to each of the inner-side and outer-side pads 5a and 6a is defined as follows: That is, in a virtual circle which has the center of the rotor 1 as its center, and passes through a centroid O of each of the inner-side and outer-side pads 5a and 6a (a geometric center O of each of frictional surfaces of the pads 5a and 6a=a geometric center O of each of the frictional materials 31 and 31 constituting the pads 5a and 6a when viewed from the rotor 1), the portion Af is positioned inwardly of a virtual tangent K at the centroid O in the radial direction of the rotor 1. Accordingly, in the case of the exemplary embodiment, the abutment part Af of the second protrusion part 19 constituting the pad-side engagement part 11a and the concave part 17 constituting the support-member-side engagement part 10a which are on the forward side in the direction of rotation of the rotor 1 is positioned inwardly of the virtual tangent K, and the abutment part Af is capable of bearing the tangential force Ff.

Further, moment (rotation force) Mf on the basis of a difference Sf between the abutment part Af and the virtual tangent K (an offset amount in the radial direction of the rotor 1) is applied to each of the inner-side and outer-side pads 5a and 6a (the moment Mf in a counterclockwise direction in FIG. 6 is applied with the abutment part Af as a pivot), and positions of portions Bf and Cf which bear the moment Mf are defined as follows: That is, the portions Bf and Cf for bearing the moment Mf are positioned at circumferential end parts of the support member 2a and outwardly of the virtual tangent K in the radial direction of the rotor 1. Accordingly, in the case of the exemplary embodiment, the abutment part Bf of an inner circumferential surface of the first protrusion part 18 (a surface in correspondence to the inner circumferential side of the rotor 1) constituting the pad-side engagement part 11a and an outer circumferential surface of the convex part 16 (a surface in correspondence to the outer circumferential side of the rotor 1) constituting the support-member-side engagement part 10a which are on the forward side in the direction of rotation of the rotor 1 during the forward rotation of the rotor 1, and the abutment part Cf of an outer circumferential surface of the third protrusion part 21 (a surface in correspondence to the outer circumferential side of the rotor 1) constituting the pad-side engagement part 11b and an inner surface of the convex part 16 (a surface in correspondence to the inner circumferential side of the rotor 1) constituting the support-member-side engagement part 10a which are on the forward side in the direction of rotation of the rotor 1 during the reverse rotation of the rotor 1 are positioned outwardly of the virtual tangent K, and the abutment parts Bf and Cf are capable of bearing the moment Mf.

Furthermore, in the case of the exemplary embodiment, among the abutment parts of the pad-side engagement parts 11a and 11b and the support-member-side engagement parts 10a and 10a, a position of a portion Ar which is on the forward side in the direction of rotation of the rotor 1 during the reverse rotation of the rotor 1, and bears tangential force Fr applied to each of the inner-side and outer-side pads 5a and 5b is positioned outwardly of the virtual tangent K in the radial direction of the rotor 1. Accordingly, in the case of the exemplary embodiment, the abutment part Ar of the second recessed part 22 constituting the pad-side engagement part 11b and the convex part 16 constituting the support-member-side engagement part 10a which are on the forward side in the direction of rotation of the rotor 1 during the reverse rotation of the rotor 1 is positioned outwardly of the virtual tangent K, and the abutment part Ar is capable of bearing the tangential force Fr. In addition, among the pad-side engagement parts 11a and 11b, the inclined surface parts 29 are also provided at the pad-side engagement parts 11b which are on the backward side in the direction of rotation of the rotor 1 (the rotation-out side and, e.g., the right side in FIG. 6) during the forward rotation of the rotor 1, and portions which are at end portions of the inclined surface parts 29 and most protruding in the circumferential direction serve as the third protrusion parts 21. Each of the inclined surface parts 29 is inclined inwardly in the radial direction of the rotor 1 as it goes toward the centroid O in the direction of the virtual tangent K. The above-described inclined surface parts 29 constituting the third protrusion parts 21 are pressed by the second pressing parts 30 of the pad clips 15b and 15b.

In the case of the exemplary embodiment constituted in the above-described manner, it is possible to achieve the stabilization of the attitudes of the inner-side and outer-side pads 5a and 6a, and reductions in the drag and the vibration (the abnormal noise and the judder) of the pads 5a and 6a.

That is, each of the pads 5a and 6a is supported (held) by the following three points Af, Bf, and Cf with respect to the support member 2a during the forward rotation of the rotor 1. First, one of the points corresponds to the portion Af which is on the forward side in the direction of rotation of the rotor 1 during the forward rotation (the forward travel) of the rotor 1, and bears the tangential force Ff applied to each of the pads 5a and 6a, and the portion Af is positioned inwardly of the virtual tangent K in the radial direction of the rotor 1. The remaining two points correspond to the portions Bf and Cf which bear the moment Mf applied to each of the pads 5a and 6a, and the portions Bf and Cf are positioned at the circumferential both end parts of the support member 2b, and outwardly of the virtual tangent K in the radial direction. Accordingly, it is possible to enlarge {increase (widen) the width in the radial direction of the rotor 1} a triangle obtained by joining the three supportive points (a triangle indicated by a diagonal lattice pattern in FIG. 6), and facilitate the securement of support stiffness of the pads 5a and 6a in the axial direction of the rotor. As the result, the pads 5a and 6a become less likely to swing in the axial direction of the rotor with the triangle obtained by joining the three supportive points as the swing center, and the stabilization of the attitudes of the pads 5a and 6a can be achieved.

Moreover, since the two points Bf and Cf out of the three supportive points Af, Bf, and Cf which constitute the triangle are positioned outwardly of the virtual tangent K in the radial direction, concurrently with the swing of the rotor 1 in the axial direction at the time of release of the braking, when the pads 5a and 6a are pressed in a direction moving away from the rotor 1 by axial side surfaces of the rotor 1, it is possible to reliably displace (retract) the pads 5a and 6a in the direction moving away from the rotor 1 on the basis of the pressing. In particular, the swing amount of the rotor 1 in the axial direction increases as it goes outward in the radial direction of the rotor 1 and, in the case of the exemplary embodiment, as described above, since the two points Bf and Cf out of the three supportive points Af, Bf, and Cf are positioned outwardly of the virtual tangent K in the radial direction, the triangle obtained by joining the three supportive points Af, Bf, and Cf and the portions pressed by the rotor 1 can be superimposed on each other or brought toward each other in the radial direction of the rotor 1. Consequently, it is possible to secure the support stiffness (render the pads less likely to swing) as described above, and cause the pads 5a and 6a to reliably recede while the stable attitudes of the pads 5a and 6a are maintained, and it is possible to thereby achieve reductions in the drag of the pads 5a and 6a with respect to the rotor 1 and in the vibration (the abnormal noise and the judder) of the pads 5a and 6a.

Furthermore, in the case of the exemplary embodiment, it is possible to have the same direction for the moment Mf during the forward rotation and the moment Mr during the reverse rotation which are applied to the pads 5a and 6a. That is, on the basis of the difference Sf between the abutment part Af and the virtual tangent K (a direction of the tangential force Ff applied to the centroid O), the moment Mf during the forward rotation is applied in the counterclockwise direction in FIG. 6 with the abutment part Af as the pivot and, on the basis of the difference (the offset amount in the radial direction of the rotor 1) Sr between the abutment part Ar and the virtual tangent K (the direction of the tangential force Fr applied to the centroid O), the moment Mr during the reverse direction is also applied in the counterclockwise direction in FIG. 6 with the abutment part Ar as the pivot. Accordingly, since it is possible to have the same direction for the moment Mf during the forward rotation and for the moment Mr during the reverse rotation which are applied to the pads 5a and 6a, as described above, the elastic force of the pad clips 15a and 15b for pressing the pads 5a and 6a can be imparted in the same direction (the counterclockwise direction in FIG. 6) as those of application of the moments Mr and Mf.

Consequently, it is appropriate to press the pads 5a and 6a in the same direction (the same direction as those of the moments Mf and Mr) at all times, i.e., press the pads 5a and 6a using the first and second pressing parts 26 and 30 of the pad clips 15a and 15b in the counterclockwise direction in FIG. 6, and the prevention of the pads 5a and 6a from rattling can be achieved more reliably. In other words, it is possible to cause the abutment parts of the pads 5a and 6a and the support member 2a (the abutment parts of the pad-side engagement parts 11a and 11b and the support-member-side engagement parts 10a and 10a) to be present in the same direction at all times, and prevent the occurrence of the abnormal noise resulting from the abutment (collision) of the engagement parts which are on the forward side in the direction of rotation of the rotor 1 when the braking is started irrespective of the forward or reverse rotation. In addition, since the direction in which the the elastic force of the pad clips 15a and 15a is imparted and the direction in which the moments Mf and Mr are applied become the same direction (do not repel each other), the wear of the pad clips 15a and 15b can be suppressed. Further, it is possible to render the force (the restraining force) for pressing the pads 5a and 6a by the pad clips 15a and 15b less likely to be reduced and, in terms of this aspect, achieve the stabilization of the attitudes of the pads 5a and 6a.

While description has been made in connection with a specific exemplary embodiment of the invention, it will be obvious to those skilled in the art that various changes and modification may be made therein without departing from the present invention. It is aimed, therefore, to cover in the appended claims all such changes and modifications falling within the true spirit and scope of the present invention.

### DESCRIPTION OF REFERENCE NUMERALS AND SIGNS

1 rotor
2, 2a support member
3 caliper
4 guide pin
5, 5a inner-side pad
6, 6a outer-side pad
7 cylinder part
8 caliper claw
9 piston
10, 10a support-member-side engagement part
11, 11a, 11b pad-side engagement part
12, 12a inner-side pressure plate
13, 13a outer-side pressure plate
14a, 14b pad clip
15a, 15b pad clip
16 convex part
17 concave part
18 first protrusion part
19 second protrusion part
20 first recessed part
21 third protrusion part
22 second recessed part
23 inner-side clip part
24 outer-side clip part
25 connection part
26 first pressing part
27 crank part
28 flat plate part
29 inclined surface part
30 second pressing part
31 frictional material

What is claimed is:

1. A disc brake comprising:
a support member to be fixed to a vehicle body so as to be adjacent to a rotor rotating together with a wheel;
a pad supportedbythe support member so as to be displaceable in an axial direction of the rotor, wherein a braking torque applied to the pad during braking is born by an engagement of support-member-side engagement parts provided at circumferential both end parts of the support member and pad-side engagement parts provided at circumferential both end parts of a pressure plate of the pad; and
pad clips disposed between the support-member-side engagement parts and the pad-side engagement parts,
wherein, among abutment parts of the pad-side engagement parts and the support-member-side engagement parts which butt to each other through the pad clips, a portion which bears a tangential force applied to the pad during a forward rotation of the rotor on a forward side of the forward rotation of the rotor is positioned inwardly in a radial direction of the rotor with respect to a virtual tangent at a centroid of the pad of a virtual circle having a center identical with a center of the rotor and passing through said centroid, and
wherein, among said abutment parts, portions which bear a rotational moment applied to the pad during the forward rotation of the rotor are positioned at the circumferential both end parts of the support member and outwardly in the radial direction of the rotor with respect to the virtual tangent.

2. The disc brake according to claim 1, wherein, among said abutment parts, a portion which bears a tangential force applied to the pad during a reverse rotation of the rotor on a forward side of the reverse rotation of the rotor is positioned outwardly in the radial direction of the rotor with respect to the virtual tangent,
wherein one of the pad-side engagement parts which is on a backward side of the forward rotation during the forward rotation of the rotor includes a inclined surface part which is inclined inwardly in the radial direction of the rotor as it goes toward the centroid in a direction of the virtual tangent, and
the inclined surface part is pressed by one of the pad clips.

3. The disc brake according to claim 1, further comprising: a caliper which is supported by a part of the support member and configured to press the pad toward a surface of the rotor.
